(19) United States
(12) Patent Application Publication
(10) Pub. No.: US 2007/0176558 A1
(43) Pub. Date: Aug. 2, 2007

(54) Plasma display panel and method for manufacturing the same

(75) Inventors: Hsu-Pin Kao, Pingjhen City (TW); Jang-Jeng Liang, Taoyuan City (TW); Sheng-Wen Hsu, Taipei City (TW); Hsu-Chia Kao, Pingjhen City (TW); Yi-Sheng Yu, Taoyuan City (TW)

Correspondence Address: BIRCH STEWART KOLASCH & BIRCH, PO BOX 747, FALLS CHURCH, VA, 22040-0747, US

(73) Assignee: MARKETECH INTERNATIONAL CORP.

(21) Appl. No.: 11/657,515

(22) Filed: Jan. 25, 2007

(30) Foreign Application Priority Data
Jan. 27, 2006 (TW) 095103374

(51) Int. Cl. H01J 61/40; H01J 17/49

(52) U.S. Cl. 313/587; 313/582; 313/586; 313/112

(57) ABSTRACT

The invention discloses a plasma display panel (PDP). The PDP grounds an exposed transparent conductive layer to the inner component thereof, so as to shield off electromagnetic interference (EMI). Accordingly, there is no metal structure in the second protective layer formed on the transparent conductive layer, such that the second protective layer can be easily attached onto the transparent conductive layer. Therefore, the manufacturing of PDP is getting much easier, and the yield rate will then increase.

### BACKGROUND OF THE INVENTION

1. Field of the Invention

The invention relates to a plasma display panel (PDP) and method for manufacturing the same.

2. Description of the Prior Art

Referring to FIG. 1, FIG. 1 is a schematic diagram illustrating the conventional PDP 1. As shown in FIG. 1, the conventional PDP 1 includes a front panel 10 and a back panel 12. The front panel 10 includes a protective layer 100 such as MgO, a dielectric layer 102, at least one bus electrode 104, a transparent conductive layer 106 such as ITO, a glass substrate 108 and a filter glass 110. The filter glass 110 is used for improving contrast and color performance of the PDP 1. Furthermore, the filter glass 110 has a metal structure therein capable of shielding off electromagnetic interference (EMI).

Referring to FIGS. 2A through 2D, FIGS. 2A through 2D respectively illustrate the process of manufacturing the PDP 1 shown in FIG. 1. As shown in FIG. 2A, at start, the glass substrate 108 is provided, and then the transparent conductive layer 106 is formed on the glass substrate 108. As shown in FIG. 2B, parts of the transparent conductive layer 106 are removed to form at least one electrode 106. As shown in FIG. 2C, each of the metal electrodes 104 is formed on each corresponding electrode 106. As shown in FIG. 2D, the dielectric layer 102 is then formed on the glass substrate 108 and further covers each of the electrodes 106 and metal electrodes 104. As shown in FIG. 2E, the protective layer 100 is then formed on the dielectric layer 102. As shown in FIG. 2F, the back panel is then attached to the protective layer 100 of the front panel 10. As shown in FIG. 2G, the filter glass 110 is then attached to the glass substrate 108. Accordingly, the conventional PDP 1 is completed.

In the aforementioned prior art, the filter glass 110 can be replaced by a filter film, so as to improve the quality of the PDP 1. However, there should be a metal structure within the filter glass 110 or the filter film, so as to shield off EMI. Consequently, it will be difficult to attach the filter glass 110 or the filter film to the glass substrate 108 of the front panel due to the metal structure, so that the manufacturing process is getting much more difficult, and then the yield rate will decrease.

Therefore, the scope of the invention is to provide a PDP and method for manufacturing the same to solve the aforementioned problems.

### SUMMARY OF THE INVENTION

The scope of the invention is to provide a PDP and method for manufacturing the same. The PDP grounds an exposed transparent conductive layer to the inner component thereof, so as to shield off EMI without additional metal structure.

According to a preferred embodiment, the PDP of the invention includes a front panel and a back panel. The front panel includes a glass substrate, a transparent conductive layer, at least one bus electrode, a dielectric layer, a first protective layer and a second protective layer.

In this embodiment, the glass substrate has a first surface and a second surface opposite to the first surface. The transparent conductive layer is formed on the first surface of the glass substrate. The bus electrodes are formed on the second surface of the glass substrate and used for providing a current. The dielectric layer is formed on the second surface of the glass substrate and covers the bus electrodes. The dielectric layer is used for restraining the current, so as to accumulating wall charge. The first protective layer is formed on the dielectric layer and used for preventing the front panel from being attacked by ions and increasing secondary electrons. The second protective layer is formed on the transparent conductive layer and used for improving contrast and color performance of the PDP and protecting the front panel from damage. The back panel is attached to the first protective layer of the front panel to complete the PDP.

According to the aforementioned embodiment, an area of the second protective layer is smaller than that of the transparent conductive layer, such that the exposed transparent conductive layer is capable of being grounded to the inner component of the PDP, so as to shield off EMI.

Therefore, since parts of the transparent conductive layer are exposed out of the second protective layer, the exposed transparent conductive layer is capable of being grounded to the inner component of the PDP, so as to shield off EMI. In other words, there is no additional metal structure in the second protective layer, such that the second protective layer can be easily attached onto the transparent conductive layer. Therefore, the manufacturing of PDP is getting much easier, and the yield rate will then increase.

The advantage and spirit of the invention may be understood by the following recitations together with the appended drawings.

### BRIEF DESCRIPTION OF THE APPENDED DRAWINGS

FIG. 1 is a schematic diagram illustrating the conventional PDP.

FIGS. 2A through 2D respectively illustrate the process of manufacturing the PDP shown in FIG. 1.

FIG. 3A is a schematic diagram illustrating the PDP according to a preferred embodiment of the invention.

FIG. 3B is a top view illustrating the PDP shown in FIG. 3A.

FIGS. 4A through 4D respectively illustrate the process of manufacturing the PDP shown in FIG. 3A.

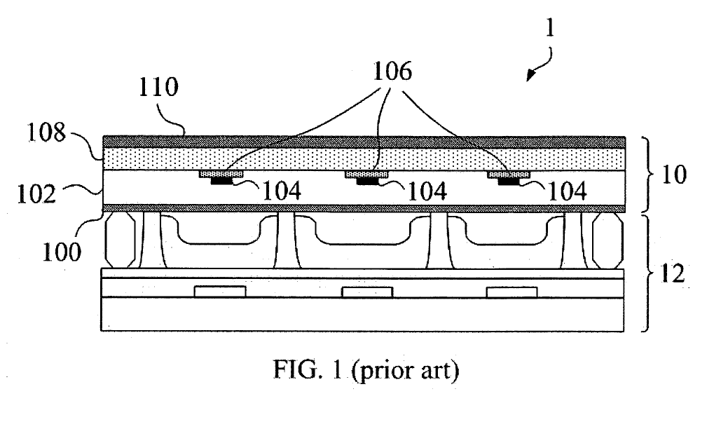

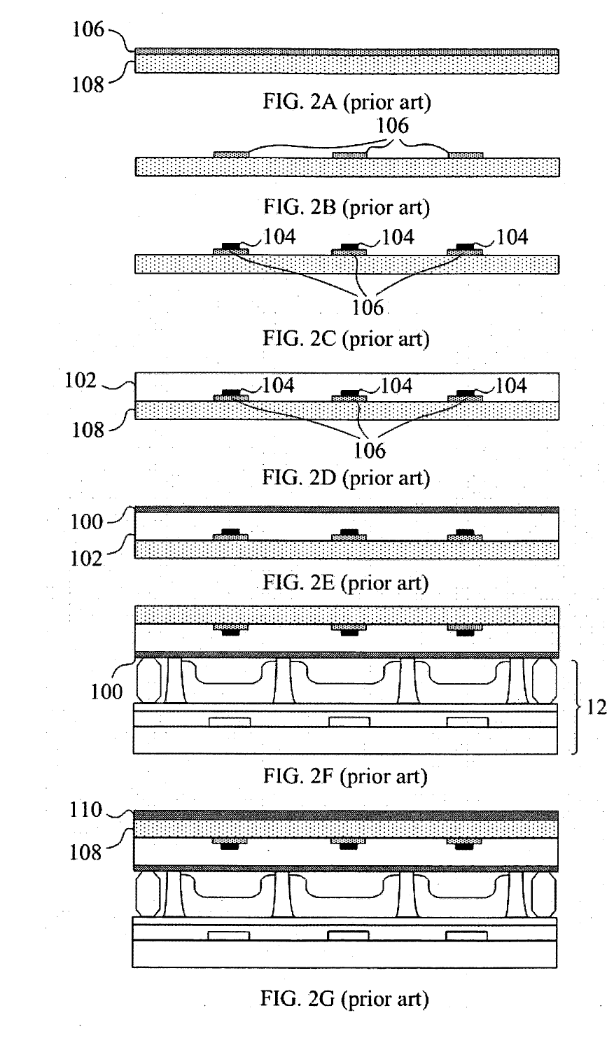

### DETAILED DESCRIPTION OF THE INVENTION

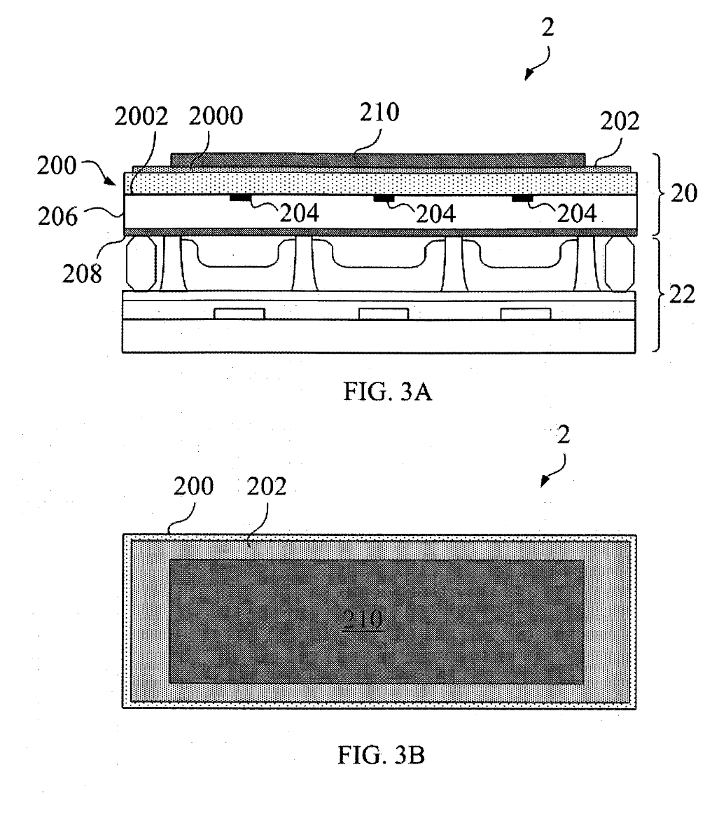

Referring to FIG. 3A, FIG. 3A is a schematic diagram illustrating the PDP 2 according to a preferred embodiment of the invention. The PDP 2 includes a front panel 20 and a back panel 22. The front panel 20 includes a glass substrate 200, a transparent conductive layer 202, at least one bus electrodes 204, a dielectric layer 206, a first protective layer 208 and a second protective layer 210. In this embodiment, the transparent conductive layer can be made of ITO, SnO₂ or the like, the first protective layer can be made of MgO or the like, and the second protective layer can be a thick film.

As shown in FIG. 3A, the glass substrate 200 has a first surface 2000 and a second surface 2002 opposite to the first surface 2000. The transparent conductive layer 202 is formed on the first surface 2000 of the glass substrate 200. The bus electrodes 204 are formed on the second surface 2002 of the glass substrate 200 and used for providing a current. The dielectric layer 206 is formed on the second surface 2002 of the glass substrate 200 and covers the bus electrodes 204. The dielectric layer 206 is used for restraining the current, so as to accumulating wall charge. The first protective layer 208 is formed on the dielectric layer 206 and used for preventing the front panel 20 of the PDP 2 from being attacked by ions and increasing secondary electrons. The second protective layer 210 is formed on the transparent conductive layer 202 and used for improving contrast and color performance of the PDP 2 and protecting the front panel 20 from damage. The back panel 22 is attached to the first protective layer 208 of the front panel 20 to complete the PDP 2.

In this embodiment, the second protective layer 210 is formed on the transparent conductive layer 202 of the front panel 20 by adhesion. In another preferred embodiment, the second protective layer 210 can be formed on the transparent conductive layer 202 of the front panel 20 by printing. In another preferred embodiment, the second protective layer 210 can be formed on the transparent conductive layer 202 of the front panel 20 by spraying or in another manner.

Referring to FIG. 3B, FIG. 3B is a top view illustrating the PDP 2 shown in FIG. 3A. As shown in FIG. 3B, the area of the second protective layer is smaller than that of the transparent conductive layer 202, such that the exposed part of the transparent conductive layer 202 can be grounded to the inner component (not shown) of the PDP 2, so as to shield off EMI. Accordingly, there is no additional metal structure in the second protective layer 210, such that the second protective layer 210 can be easily attached onto the transparent conductive layer 202. Therefore, the manufacturing of PDP 2 is getting much easier, and the yield rate will then increase.

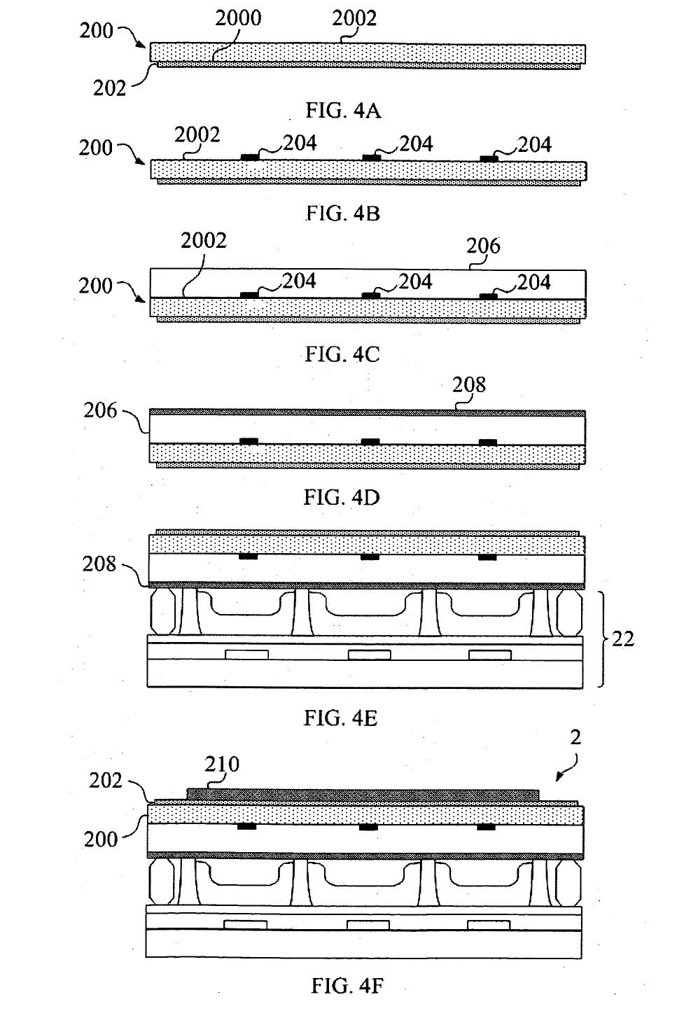

Referring to FIGS. 4A through 4F, FIGS. 4A through 4D respectively illustrate the process of manufacturing the PDP 2 shown in FIG. 3A. The method of the invention for manufacturing the PDP 2 includes the following steps. At start, as shown in FIG. 4A, the glass substrate 200 is provided, and then the transparent conductive layer 202 is formed on the first surface 2000 of the glass substrate 200. Afterward, as shown in FIG. 4B, the bus electrodes 204 are formed on the second surface 2002 of the glass substrate 200. As shown in FIG. 4C, the dielectric layer 206 is then formed on the second surface 2002 of the glass substrate 200 and covers the bus electrodes 204. As shown in FIG. 4D, the first protective layer 208 is then formed on the dielectric layer 206. As shown in FIG. 4E, the back panel 22 is then attached to the first protective layer 208. Finally, as shown in FIG. 4F, the second protective layer 210 is formed on the transparent conductive layer 202. Accordingly, the PDP 2 is completed.

Compared to the prior art, since parts of the transparent conductive layer are exposed out of the second protective layer, the exposed transparent conductive layer is capable of being grounded to the inner component of the PDP, so as to shield off EMI. In other words, there is no additional metal structure in the second protective layer, such that the second protective layer can be easily attached onto the transparent conductive layer. Therefore, the manufacturing of PDP is getting much easier, and the yield rate will then increase.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A plasma display panel comprising:
a front panel comprising:
a glass substrate having a first surface and a second surface opposite to the first surface;
a transparent conductive layer being formed on the first surface of the glass substrate;
at least one bus electrode being formed on the second surface of the glass substrate and used for providing a current;
a dielectric layer being formed on the second surface of the glass substrate and covering the at least one bus electrode, the dielectric layer being used for restraining the current, so as to accumulating wall charge;
a first protective layer being formed on the dielectric layer and used for preventing the front panel from being attacked by ions and increasing secondary electrons;
a second protective layer being formed on the transparent conductive layer and used for improving contrast and color performance of the plasma display panel and protecting the front panel from damage; and
a back panel being attached to the first protective layer of the front panel to complete the plasma display panel;
wherein an area of the second protective layer is smaller than that of the transparent conductive layer, such that the exposed transparent conductive layer is capable of being grounded to the plasma display panel, so as to shield off electromagnetic interference (EMI).

2. The plasma display panel of claim 1, wherein the transparent conductive layer is made of ITO.

3. The plasma display panel of claim 1, wherein the transparent conductive layer is made of SnO₂.

4. The plasma display panel of claim 1, wherein the first protective layer is made of MgO.

5. The plasma display panel of claim 1, wherein the second protective layer is a thick film.

6. The plasma display panel of claim 1, wherein the second protective layer is formed on the transparent conductive layer of the front panel by adhesion.

7. The plasma display panel of claim 1, wherein the second protective layer is formed on the transparent conductive layer of the front panel by printing.

8. The plasma display panel of claim 1, wherein the second protective layer is formed on the transparent conductive layer of the front panel by spraying.

9. A method for manufacturing a plasma display panel, the method comprising the steps of:
providing a glass substrate having a first surface and a second surface opposite to the first surface;
forming a transparent conductive layer on the first surface of the glass substrate;
forming at least one bus electrode on the second surface of the glass substrate, the at least one bus electrode being used for providing a current;
forming a dielectric layer on the second surface of the glass substrate, the dielectric layer being used for covering the at least one bus electrode and restraining the current, so as to accumulate wall charge;
forming a first protective layer on the dielectric layer, the first protective layer being used for preventing the dielectric layer from being attacked by ions and increasing secondary electrons;
attaching a back panel to the first protective layer; and
forming a second protective layer on the transparent conductive layer, the second protective layer being used for improving contrast and color performance of the plasma display panel and protecting the front panel from damage;
wherein an area of the second protective layer is smaller than that of the transparent conductive layer, such that the exposed transparent conductive layer is capable of being grounded to the plasma display panel, so as to shield off electromagnetic interference (EMI).

10. The method of claim 9, wherein a front panel of the plasma display panel consists of the second protective layer, the transparent conductive layer, the glass substrate, the at least one bus electrode, the dielectric layer and the first protective layer.

11. The method of claim 9, wherein the transparent conductive layer is made of ITO.

12. The method of claim 9, wherein the transparent conductive layer is made of SnO₂.

13. The method of claim 9, wherein the first protective layer is made of MgO.

14. The method of claim 9, wherein the second protective layer is a thick film.

15. The method of claim 9, wherein the second protective layer is formed on the transparent conductive layer of the front panel by adhesion.

16. The method of claim 9, wherein the second protective layer is formed on the transparent conductive layer of the front panel by printing.

17. The method of claim 9, wherein the second protective layer is formed on the transparent conductive layer of the front panel by spraying.
